(19) United States
(12) Patent Application Publication
(10) Pub. No.: US 2026/0298135 A1
(43) Pub. Date: Oct. 1, 2026

(54) TURBOFAN ENGINE CONVERTED FROM PRODUCING THRUST POWER TO PRODUCING SHAFT POWER AND CORRESPONDING METHOD

(71) Applicant: TJet Holdings Inc., Danville, CA (US)

(72) Inventors: Michael E. Turner, Danville, CA (US); Robin Sipe, Baldonnel (CA)

(21) Appl. No.: 19/563,093

(22) Filed: Mar. 11, 2026

Related U.S. Application Data
(60) Provisional application No. 63/771,487, filed on Mar. 13, 2025.

(51) Int. Cl. F02C 3/06; F02C 3/14; F02C 9/18

(52) U.S. Cl. CPC F02C 3/06; F02C 3/14; F02C 9/18; F05D 2230/80; F05D 2240/35; F05D 2260/606

(57) ABSTRACT

A converted turbofan engine for generating electricity includes a body having a fluid pathway that extends between first and second ends of the body to control direction of fluid, a bypass duct disposed on the body, and a bypass opening extending through the bypass duct and including a mounting plate attached to an end of the bypass duct. The engine further includes an inlet bellmouth assembly connected to the body, a drive shaft connected to a shaft within the body, and a fan connected to the shaft, such that the fan is covered by the inlet bellmouth assembly. The fan includes fan blade(s), where a tip of each fan blade is within a threshold distance to an inner wall of the inlet bellmouth assembly. A diverging exhaust duct disposed at the second end of the body is configured to decrease speed of exhaust exiting the body.

### CROSS-REFERENCE TO RELATED APPLICATIONS

The present application claims priority to copending U.S. Provisional Patent Application Ser. No. 63/771,487, which was filed on Mar. 13, 2025, for “TURBOFAN ENGINE CONVERTED FROM PRODUCING THRUST POWER TO PRODUCING SHAFT POWER AND CORRESPONDING METHOD”, WHICH IS HEREBY INCORPORATED BY reference.

### BRIEF DESCRIPTION OF THE DRAWINGS AND OVERVIEW

The advantages of the invention described above, together with further advantages, may be better understood by referring to the following description taken in conjunction with the accompanying drawings. The drawings are not necessarily to scale, emphasis instead generally being placed upon illustrating the principles of the invention.

In describing preferred embodiments illustrated in the drawings, specific terminology is employed herein for the sake of clarity. However, this disclosure is not intended to be limited to the specific terminology so selected, and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that, while various examples are discussed herein, the inventive aspects of this disclosure are not limited to such examples described herein.

FIG. 1 illustrates a cross-sectional view of an engine according to one or more embodiments.

FIG. 2 is an example of a converted engine according to the one or more embodiments.

FIG. 3A illustrates the converted engine with values open according to the one or more embodiments.

FIG. 3B illustrates the converted engine with values closed according to the one or more embodiments.

FIG. 4 is a perspective view of a combustor assembly for a converted turbofan engine according to one or more embodiments.

FIG. 5 is a top perspective view of the combustor assembly of FIG. 4.

FIG. 6 is a top plan view of the combustor assembly of FIG. 4.

FIG. 7 is a front elevation view of the combustor assembly of FIG. 4.

FIG. 8 is an enlarged perspective view of a cone module of the combustor assembly of FIG. 4.

FIG. 9 is a bottom perspective view of the cone module of FIG. 8.

FIG. 10 is a top plan view of the cone module of FIG. 8, showing section line A-A.

FIG. 11 is a front elevation view of the cone module of FIG. 8.

FIG. 12 is a sectional side elevation view taken of the cone module of FIG. 8 taken along section line A-A.

FIG. 13 is a sectional perspective of the cone module of FIG. 8 taken along section line A-A.

FIG. 14 is an alternative sectional perspective view of the cone module of FIG. 8 taken along section line A-A.

FIG. 15 is a perspective view of an upper cap of the combustor assembly of FIG. 4.

FIG. 16 is a bottom isometric view of the multi upper cap of FIG. 15.

FIG. 17 is a top plan view of the upper cap of FIG. 15.

FIG. 18 is a front elevation view of the upper cap of FIG. 15.

FIGS. 19-22 illustrate various views of a low pressure compressor 0-stage blade assembly of a converted engine according to one or more embodiments.

FIGS. 23-26 illustrate various views of a section of an inlet bellmouth with the low pressure compressor 0-stage blade assembly of FIGS. 19-22.

FIG. 27 illustrates a cross-sectional view of the converted engine with the low pressure compressor 0-stage blade assembly according to one or more embodiments.

### SUMMARY

According to one embodiment of the present invention, in a method of converting engines into converted engines, an engine is provided as having: a body having a first end, a second end that is opposite the first end, and a fluid pathway that extends from the first end of the body to the second end of the body to control direction of fluid moving through body; a shaft that is disposed within the body; a bypass duct that is disposed on the body, where the bypass duct includes a first end, a second end that is opposite the first end, and a bypass opening extending from the first end of the bypass duct to the second end of the bypass duct; a fan disposed at the first end of the body and connected to the shaft, where the fan includes one or more fan blades that rotate to draw fluid into the fluid pathway and the first end of the bypass duct; a converging exhaust duct disposed at the second end of the body, where the converging exhaust duct is configured to increase speed of exhaust exiting the body; and a valve that is configured to control flow of fluid from the fluid pathway of the body into the bypass duct. The engine is converted into a converted engine by: attaching an inlet bellmouth assembly to the first end of the body, such that an inner wall of the inlet bellmouth assembly covers the fan; cutting the one or more fan blades or replacing the one or more fan blades to create one or more new fan blades, where a length of each new fan blade is selected such that a tip of the new fan blade is within a threshold distance to the inner wall of the inlet bellmouth assembly; attaching a drive shaft to the shaft; attaching a blanking plate to second end of the bypass duct, such that fluid flowing into the bypass duct from the fluid pathway of the body, via the valve, is blocked from exiting the bypass duct via the second end; and replacing the converging exhaust duct with a diverging exhaust duct, where the diverging exhaust duct is configured to decrease speed of exhaust exiting the body.

According to another embodiment, a converted turbofan engine includes: a body having a first end, a second end that is opposite the first end, and a fluid pathway that extends from the first end of the body to the second end of the body to control direction of fluid moving through body; a bypass duct that is disposed on the body, where the bypass duct includes a first end, a second end that is opposite the first end, and a bypass opening extending from the first end of the bypass duct to the second end of the bypass duct, wherein the bypass duct includes a mounting plate attached to the second end of the bypass duct; an inlet bellmouth assembly connected to the first end of the body, where the inlet bellmouth assembly includes an inner wall; a drive shaft that is connected to a shaft disposed within the body; a fan, disposed at the first end of the body and connected to the shaft, such that the fan is covered by the inlet bellmouth assembly, where the fan includes one or more fan blades that each have a length such that a tip of the fan blade is within a threshold distance to the inner wall of the inlet bellmouth assembly; and a diverging exhaust duct disposed at the second end of the body, where the diverging exhaust duct is configured to decrease speed of exhaust exiting the body.

In one aspect of the embodiment, the converted turbofan engine further includes a combustor assembly. The combustor assembly includes: a housing; a fuel distribution manifold; a plurality of injection tubes coupled to the fuel distribution manifold, where each injection tube comprises a plurality of fuel apertures; a plurality of cone modules, where a first end of the plurality of cone modules is coupled to the housing, and the fuel distribution manifold resides proximate to a second end of the plurality of cone modules, where each injection is coupled to one of the plurality of cone modules, where each cone module comprises: a plurality of air admission slots; a combustion chamber; an ignition port; and a vortex breakdown zone, where fuel and air are premixed in the combustion chamber prior to combustion and ignition downstream in the vortex breakdown zone.

In another aspect of the embodiment, the converted turbofan engine further includes a plurality of low pressure compressor 0-stage blades.

### DETAILED DESCRIPTION OF AN ILLUSTRATIVE EMBODIMENT

### Configuration and Operation of a Conventional Turbofan Engine that Primarily Produces Thrust Power

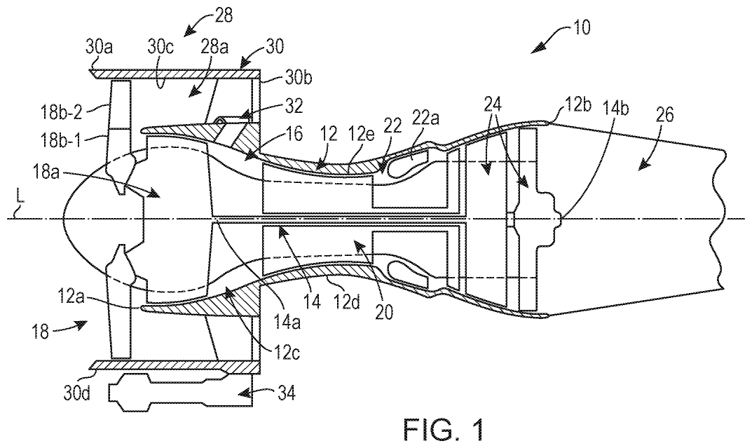

FIG. 1 illustrates a cross-sectional view of an engine 10. The engine 10 may represent an engine before modification/conversion according to the one or more embodiments as described herein. Before modification/conversion, the engine 10 may be a reaction engine that generates thrust via discharge of fluid, which may be any material (e.g., gas, liquid, etc.) that moves or flows due to applied shear stress or an external force. More specifically, the engine 10 may be a turbofan engine, which is a type of reaction engine that breathes air in order to produce thrust. The thrust in the turbofan engine is achieved by discharging both (low pressure bypass) air and a high-pressure exhaust, which is generated by igniting fuel with the air taken in by the engine 10. In some embodiments, the engine 10 may be a turbofan engine corresponding to the CFM56 series of turbofan engines, which are manufactured by CFM International (a joint venture between General Electric Company (d/b/a GE Aerospace) and Safran Aircraft Engines (a division of Safran S.A.)). Alternatively, the engine 10 may also be any engine that is similar in configuration and/or operation to the CFM56 series of turbofan engines.

The engine 10 may comprise a body (or core) 12 that includes a first end 12a, a second end 12b, an opening 12c that extends from the first end 12a to the second end 12b, an exterior surface 12d, and an interior surface 12e. A shaft 14 may be disposed in the opening 12c, such that the shaft 14 is concentric with the body 12 along a longitudinal axis L. The shaft 14 may include a first end 14a and a second end 14b. In addition, the shaft 14 may be surrounded by an outer shaft (not shown) that may be shorter in length than the shaft 14 and may be concentric with the shaft 14. The outer shaft may rotate independently of shaft 14. In addition, a fluid pathway 16 may be disposed between the interior surface 12e of the body 12 and the shaft 14. The fluid pathway 16 is configured to control the movement or flow of fluid (e.g., air or liquid) that enters the engine 10.

The engine 10 may further include a fan or propeller 18 that is configured to exert linear thrust upon a fluid that is drawn in by the fan 18. In other words, the fan 18 may be configured to direct fluid into the engine 10. The fan 18 may include a hub 18a and one or more fan blades 18b that extend outwardly from the hub 18a, in which each fan blade 18b includes a root that is connected to the hub 18a and a tip, which is the furthest point on the fan blade 18b from the root. The hub 18a may be mounted to the first end 14a of the shaft 14.

Further, each fan blade 18b may be set at a pitch to form a helical spiral which, when rotated, exerts linear thrust upon incoming fluid. In addition, each fan blade 18b may include an impulse profile at the root and reaction profile at the tip to account for the varying blade speed and aerodynamic forces along its length due to rotation. Because each fan blade 18b moves slower near the root, an impulse profile is used to maximize lift and airflow compression. Because each fan blade 18b moves faster near the tip, a reaction profile is used to efficiently transfer energy through velocity changes, thereby reducing draft and preventing excessive pressure loss.

The engine 10 may further include a compressor 20 that includes at least one of a high-pressure compressor and a low-pressure compressor. The compressor 20 increases the pressure of the incoming fluid (as well as its density) by compressing it and directing the compressed air to a combustion chamber 22. The combustion chamber 22 mixes the high-pressure air with fuel, by way of fuel injector 22a, and ignites it producing high-temperature, high-energy gases that drive the engine 10 generate thrust. A turbine 24 extracts energy from the expanding gases causing the turbine 24 to spin. The turbine 24 may include a high-pressure turbine and a low-pressure turbine that is disposed after the high-pressure turbine and before an exhaust duct 26, in which the high-pressure turbine drives the high-pressure compressor via the outer shaft surrounding the shaft 14 and the low-pressure turbine drives the low-pressure compressor and the fan 18 via the shaft 14, thereby sustaining the continuous operation of engine 10. The exhaust duct 26, which carries the exhaust gasses from the combustion chamber 22, tapers to form a converging nozzle. This nozzle accelerates the exhaust gases as they are expelled, helping to generate thrust.

A bypass duct 28, which is formed by a casing 30 that surrounds the body 12. The casing 30 includes a first end 30a, a second end 30b, an interior surface 30c, and an exterior surface 30d. The first end 30a may line up with or extend beyond the fan blade 18b of the fan 18. The second 30b may extend to a position that may terminate before the second end 12b of the body 12. An opening (i.e., bypass opening 28a) is formed between the interior surface 30c of the casing 30 and the exterior surface 12d of the body 12.

The bypass duct 28 is a pathway that directs a portion of the incoming fluid (i.e., incoming air) around the core 12 of the engine 10, rather than through the combustion chamber 22. This air, i.e., bypass air, is then expelled via bypass opening 28a, thereby contributing to the thrust of the engine 10 without undergoing combustion. The bypass air helps increase efficiency by providing additional thrust while reducing fuel consumption and noise.

The engine 10 may also include one or more variable valves 32 that can be in either an open or closed configuration. Valves 32 help manage airflow and reduce aerodynamic instability to improve performance of engine 10. At full power or speed, the engine 10 operates more efficiently and stably, while at lower power and speed, the engine 10 can operate in an aerodynamic range that may be unstable due to mismatched ideal flows between the low pressure compressor and the high pressure compressor. To address this, the valves 32 can be opened to bleed off fluid, helping stabilize the airflow and prevent issues like the stalling of compressor 20. For example, with the valves 32 open, approximately 30% of the air can be bled off between the low-pressure compressor outlet and the inlet of the high-pressure compressor, which assists in reducing inefficiency and instability. Once engine 10 reaches approximately 90% power or speed, the valves 32 can be closed to maintain optimal efficiency and stability.

The engine 10 may also include an auxiliary gearbox 34 which is connected to shaft 14. Auxiliary gearbox 34 helps drive various components of the engine 10 such as, but not limited to, electrical generators and hydraulic pumps on the aircraft to which engine 10 may be coupled. By transferring mechanical power from the shaft 14 that is rotating, the auxiliary gearbox 34 ensure that these essential aircraft components receive the energy needed for their operation.

It should be noted that the components of the engine as described above have conventional configurations and operations as known by those skilled in the art

While the engine 10 is efficient in providing thrust to vehicles to which the engine 10 is attached, engine 10, as configured in FIG. 1, is not an effective power generating in, for example, in an industrial static environment.

### Inventive Converted Engine Producing Shaft Power with Effectively Zero Thrust Power

The one or more embodiments as described herein are directed to converting/modifying the turbofan engine 10 from a thrust producer to a shaft power producer in a static environment via rotational motion of a shaft as will be described in further detail below. Therefore, the one or more embodiments as described herein modify the engine 10, as described in further detail below, by converting the engine 10, which is concerned with producing thrust, to converted engine 110 for efficiently producing shaft power (e.g., rotational power) in a static environment. In an embodiment, the produced power can be used to generate electricity.

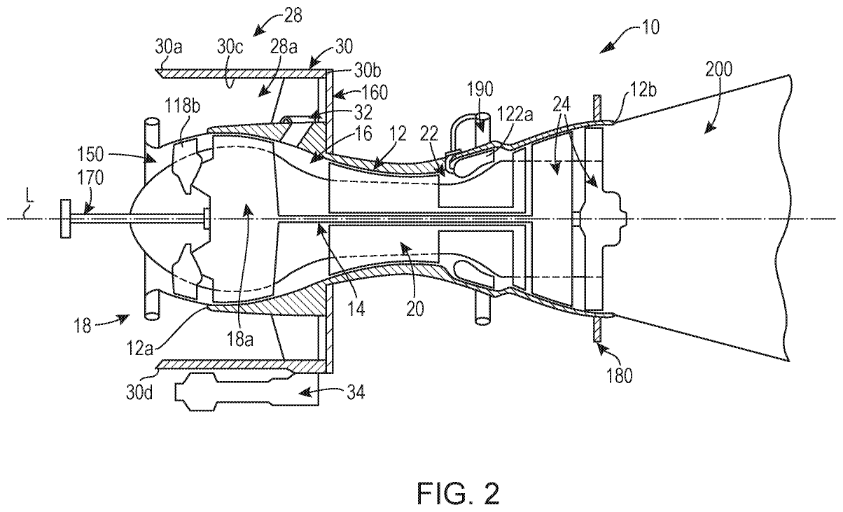

FIG. 2 is an example of a converted engine 110 according to the one or more embodiments as described herein. The converted engine 110 is achieved by modifying conventional turbofan engine 10 as will be described in further detail below.

One step in converting the engine 10 to the converted engine 110 may involve modifying or replacing the existing fan blades 18b of FIG. 1 with new fan blades 118b. When the existing fan blades 18b are modified to new fan blades 118b, the existing fan blades 18b may be cut (e.g., trimmed or cropped) to create the new fan blades 118b. In an embodiment, after cutting the existing fan blades 18b (which may include aerospace titanium alloy) to generate the new fan blades 118b, the new fan blades 118b may be machined to a final profile via, for example, a computer numerical control (CNC) 5-axis milling operation. In an alternative embodiment, the fan blades new 118b may be replaced entirely by replacement blades to produce new fan blades 118b of FIG. 2. In an embodiment, the replacement blades are carbon composite.

As depicted in FIG. 2, each new fan blade 118b has a length that is selected such that a tip of the new fan blade 118b is in close proximity to (e.g., within a threshold distance to) an inner (or interior) wall of the inlet bellmouth assembly 150, which is described in further detail below. For example, the threshold distance may be substantially .030″. As a result, a fluid pathway is created by a space between the tip of each fan blade 118b and the interior wall of the inlet bellmouth assembly 150.

As discussed previously, each fan blades 18b of a conventional engine 10 of FIG. 1 has an impulse profile at the root and a reaction profile at the tip. This design, i.e., profile, of the fan blades of a conventional engine 10 of FIG. 1 is utilized to maximize thrust production and fuel efficiency for engine 10 that is operating in a dynamic or non-static environment (e.g., cruising altitude). Since the converted engine 110 is concerned with producing shaft power instead of thrust power, the new fan blades 118b of the converted engine 110 of FIG. 2 have a reaction profile at the root and a reaction profile at the tip. The profile of the new fan blades 118b, which can be considered a single reaction profile, achieves optimal/maximum air flow for the converted engine 110 of FIG. 2. To that end, the profile of the new fan blades 118b may compress the incoming fluid before proceeding into compressor 20, which leads to increase thermodynamics and total shaft horsepower output. The angle of the reaction profile at the root, tip, and other points on the new fan blades 118b of the converted engine 110 of FIG. 2 may be selected based on the revolutions per minute (RPM) operation that are desired for the converted engine 110 or other operating characteristics associated with converted engine 110.

To maximize the effectiveness and efficiency of the fan blades 118b of converted engine 110 of FIG. 2, an inlet bellmouth assembly 150 may be included in the converted engine 110. This inlet bellmouth assembly 150 is configured to smooth the fluid flowing into the body 12 of the engine 10, thereby eliminating turbulence and flow separation, both of which negatively effect engine output, efficiency and reliability. In addition, the inlet bellmouth assembly 150 is fitted within close proximity to (e.g., within a threshold distance) the outer circumference of the new fan blades 118b, which effectively reduce pressure losses at the tip of the new fan blades 118b, since the pressure generated by the said blades is to maximize the turboshaft engine efficiency and output, any reduction of blade tip pressure losses leads to cycle optimization.

The inlet bellmouth assembly 150 may be manufactured from common metallic alloys and/or composite materials, suitable to the application. In some embodiments, the inlet bellmouth assembly 150 may be rigidly fixed to the converted engine 110 and to the modified bypass duct 28 via struts that are radially spaced along the outer maximal periphery of the bellmouth assembly 150 and that are fixed to (and/or intersect with) the modified bypass duct 128. In addition, the struts may be angled towards a rear of the converted engine 110 at substantially or approximately 45 degrees so as to prevent movement relative to the converted engine 110 and to reduce aerodynamic vibratory frequency excitation.

More specifically, a rear end of the inlet bellmouth assembly 150 may be fixed to the body 12 such that the rear end (exactly) aligns with or matches a leading edge of the body 12, thereby providing a smooth transition from the inlet bellmouth assembly 150 to the body 12. An interior width or diameter of the inlet bellmouth assembly 150 may substantially be 37.7″. A length of the inlet bellmouth assembly may substantially be 14″. An outside (or exterior) width or diameter of the inlet bellmouth assembly 150 may substantially be 46″. In an embodiment, a plenum (which may include a sheet metal housing and/or sound absorbing materials) may be attached or disposed to the inlet bellmouth 150, to direct or control incoming fluid towards the inlet bellmouth 150 as well as reduce noise originating or emanating from front of the converted engine 110.

In addition, the converted engine 110 may also include a blanking plate 160, which is configured to allow the fluid to be recirculated into a front of the converted engine 110 (e.g., before the new fan blades 118). The blanking plate 160 may be disposed at the second end 30b of the casing 30, such that the blanking plate 160 (completely) covers the second end 30b, thereby preventing any fluid from escaping from the bypass opening 28a via the now-closed second end 30b. In some embodiments, the blanking plate 160 may be an aluminum plate and/or carbon-composite sheet. It should be noted that the addition of the blanking plate 160 is advantageous over the removal of the bypass duct 28 from the converted engine 110. This is because, as discussed above, an auxiliary gearbox 34 may be attached to the casing 30. Therefore, it would be a major inconvenience (e.g., a hassle) to remove the bypass duct 28 and the auxiliary gearbox 34. A simpler solution (that saves time and resources) is to use a blanking plate 160 as described herein.

As discussed previously, the valves 32 may be placed into an open configuration to prevent aerodynamic instability. When the one or more valves 32 are in an open configuration, some fluid does not go into the body 12 of the engine but moves towards the bypass duct 28. Without the blanking plate 160 (as depicted in FIG. 1), the fluid would move through the bypass opening 28a of the bypass duct 28 towards the rear of the engine 10 (e.g., which is how a normal jet engine operates), and effectively returns to the atmosphere. It is advantageous however to not vent the fluid into the atmosphere according to the one or more embodiments as described herein. In other words, it would be better to recirculate the fluid back into the body 12, thereby eliminating the requirement for fluid piping and venting to the atmosphere. This can be achieved via the blanking plate 160, which redirects the fluid (that escaped via the valves 32) towards the front of the converted engine 110 (e.g., before the fan 18) for recirculation.

More specifically, the blanking plate 160 may be attached to the bypass duct 28 via the second end 30b of the casing 30, thereby blocking or preventing any fluid from escaping via the second end 30c of the casing 30. Specifically, fluid enters the front of the converted engine 110 and enters fluid pathway 16 and via the space between the new fan blades 118b and the interior wall of the inlet bellmouth assembly 150. As previously indicated, each new fan blade 118b has a length that is less than and also substantially matches the interior radius of the inlet bellmouth assembly. As such, the space between the new fan blades 118b and the interior wall of the inlet bellmouth assembly 150 is substantially similar.

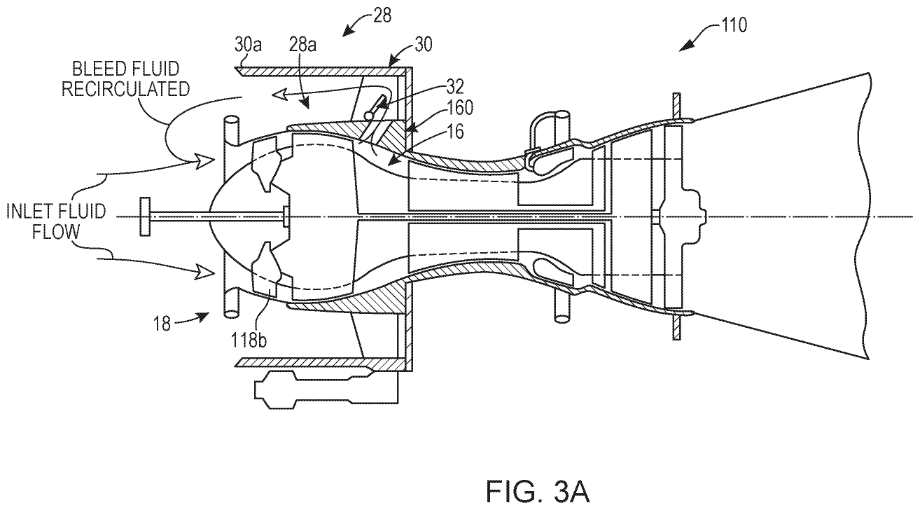

Some fluid enters the core 12 while other fluid, i.e., bypass fluid, bleeds through the passage and into bypass opening when valves 32 are open as depicted in FIG. 3A. The blanking plate 160 ensures that all the bypass fluid is redirected towards the first end 30a of the casing 30. After exiting the first end 30a, the bypass fluid recirculates (e.g., “bleed fluid recirculated”) back into the fan 18 (e.g., may be drawn in by the new fan blades 118b) and re-enters the fluid pathway 16 to assist in the aerodynamic stability of the converted engine 110 during startup.

The valve 32 may remain in the open configuration until a predetermined event occurs (e.g., until the converted engine 110 reaches 90% power or speed). When such predetermined event occurs, the valve 32 may move into a closed configuration, in which the valve 32 blocks or prevents any fluid from escaping the fluid pathway 16 via the valve 32. In an embodiment, the valves 32 may start in the opened configuration at startup and the valves can close at a particular rate or a predetermined schedule based on the RPMs of the converted engine 110. The valves 32 may close when the converted engine 110 reaches a threshold RPMs. For example, the closure of the valves 32 may increase as the RPMs of the converted engine 110 increases, and then the valves 32 may close at the threshold RPMs.

An example of the closed configuration is shown in FIG. 3B, in which the fluid entering the fan 18 (e.g., inlet fluid flow) does not enter the bypass opening 28a and, instead, continues to the compressor 20.

Further, the converted engine 110 may also include a drive shaft 170 (see FIG. 2), which is connected to the shaft 14 of the converted engine 110. The drive shaft 170 is added to the converted turboshaft engine 110 to drive external auxiliary equipment (not shown). For electrical power generation, for example, the drive shaft 170 is connected to the generator. For natural gas compression, for example, the drive shaft 170 is connected to the gas compressor. For Marine drive, for example, the drive shaft 170 is connected to the ship's propeller. Therefore, the drive shaft 170 may be coupled to any a variety of different device based on how the converted engine 110 is being used.

The existing drive shaft 14 that is internal to the converted engine 110 extends to the bypass fan disk (not shown) only, then terminates. The addition of the external drive shaft 170 allows a universal connection to the engine, which does not exist with the turbofan engine 10 before conversion (e.g., a flight CFM56 Turbofan engine). The converted engine 110 may leverage the existing bolt holes, for the spinner cap of engine 10 of FIG. 1, to attach drive shaft 170 to converted engine 110. For example, the existing bolts may be modified in size to accommodate the bolts needed to attach a plate of the drive shaft 170 to the converted engine 110.

A hole may be cut through the leading edge of the inlet spinner to accommodate the drive shaft as depicted in FIG. 2. This allows the drive shaft 117 to protrude through the inlet spinner as depicted in FIG. 2. To accommodate the drive shaft 117, existing bolt fastening the fan (including the blades) to turbine drive shaft assembly, as configured for aircraft application, are replaced with longer bolts to accommodate the thickness of an additional ground power drive flange assembly 170a, as fixed by said longer bolts to the original aircraft bypass fan mounting bolt holes. The drive flanges 170a are coupled to drive shaft 170 via industry standard flexible couplings to allow for minor misalignment. Drive flanges 170a are also industry standard and common to mechanical drive and electrical generation utilities.

In addition, the converted engine 110 may also include a torque reaction mounting plate 180 that is configured to prevent twisting of the converted engine 110 during operation due to large amounts of torque being generated. Specifically, when an engine 10 is being used in an aircraft, all of the torque produced by the engine 10 is cancelled out internally (i.e., there is zero-reaction torque). However, when the converted engine 110 is mounted to the ground to generate shaft power, the converted engine 110 produces reaction torque equal to an output shaft torque (e.g., for each action, there is an opposite and equal reaction). Consequently, to prevent damage to the converted engine 110 during operation (as a result of negative torque reaction forces), a mounting system may be used in which the converted engine 110 is bolted firmly to mounting skid rails (not shown) via a torque reaction mounting plate 180, which may include iron or steel allow material. The skid rails may be cross braced to provide a rigid structure (e.g., foundation) to which the converted engine 110 may be mounted. Specifically, a first end of the torque reaction mounting plate 180 may be attached to the second end 12b of the body 12 or the exhaust duct 26, while a second end of the torque reaction mounting plate 180 may be attached to the skid rails, such that the reaction torque is absorbed by the skid rails.

Further, the converted engine 110 may further include a natural gas fuel system A. The natural gas fuel system 190 may be configured to provide natural gas fuel to the combustion chamber 22. An advantage of using natural gas fuel is that it provides an operator of the converted engine 110 with the flexibility of fuel choice. This is because natural gas fuel is often more readily available in the volumes required for continuous operation of the converted engine 110 whether with respect to mechanical drive or power generation. In addition, natural gas may also be significantly more economical as a fuel source.

Moreover, the converted engine 110 may also include a diverging exhaust duct 200. The diverging exhaust duct 200 may replace the converging exhaust duct 26, in which the converting exhaust duct 26 may be removed from the second end 12b of the body 12 and the diverging exhaust duct 200 attached to the second end 12b of the body 12. An angle of a wall of the diverging exhaust duct 200 (which extends from an end of the duct 200 that is connected to the second end 12b of the body 12 to an opposite end) with respect to the longitudinal axis L may be substantially 40 degrees. Such replacement may be performed because, as discussed previously, the conventional converging exhaust duct 26 is configured to accelerate the exhaust gases as they are expelled, helping to generate thrust. However, the converted engine 10 remains in a static position, in which the requirement for thrust generation becomes unnecessary. Therefore, the diverging exhaust duct 200 may replace the exhaust duct 26 to reduce the thrust produced by the converted engine 110 during operation. In addition, the diverging exhaust duct may also allow maximum use of all potential heat energy in the exhaust leaving the converted engine 110. This is achieved by reducing velocity of the outgoing exhaust, which converts the potential heat energy to rotational shaft power.

### Inventive Converted Engine with Mix of Fuel with Primary Combustion Air to Stoichiometric Ratio Before Combustion

Conventional gas turbine engines utilized for industrial power generation commonly operate on natural gas fuel, primarily methane. In conventional combustor configurations, fuel is introduced directly into the primary combustion zone through simple pipe or nozzle arrangements. The injected fuel mixes with compressor discharge air within the combustion chamber and ignites once the mixture reaches a combustible ratio.

Such systems inherently operate across a range of air-to-fuel mixture ratios bounded by the Lower Explosive Limit (LEL) (i.e., lowest concentration of fuel in the air that can ignite) and Upper Explosive Limit (UEL) (i.e., maximum concentration of fuel in the air above which the air/fuel mixture is too “rich” to burn or explode). As a result, localized regions within the combustion zone may experience near-stoichiometric or fuel-rich conditions, leading to elevated peak flame temperatures.

Nitrogen oxides (NOx) form at high combustion temperatures, particularly above approximately 2600° F., due to thermal fixation of atmospheric nitrogen with oxygen. Conventional diffusion-type combustors frequently produce localized high-temperature zones that promote NOx formation. Additionally, incomplete or non-uniform fuel-air mixing may result in lean blowout conditions and the emission of unburned hydrocarbons.

In one or more embodiments, the converted turbofan engine 110 further includes an improved gas turbine combustor configured to premix natural gas fuel with primary combustion air to a substantially stoichiometric ratio prior to flame initiation. This results in a significant reduction in NOx formation.

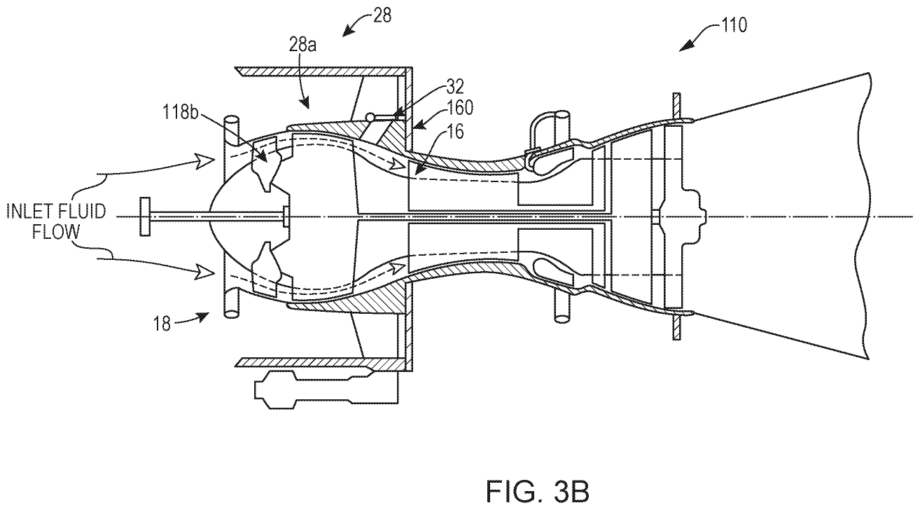

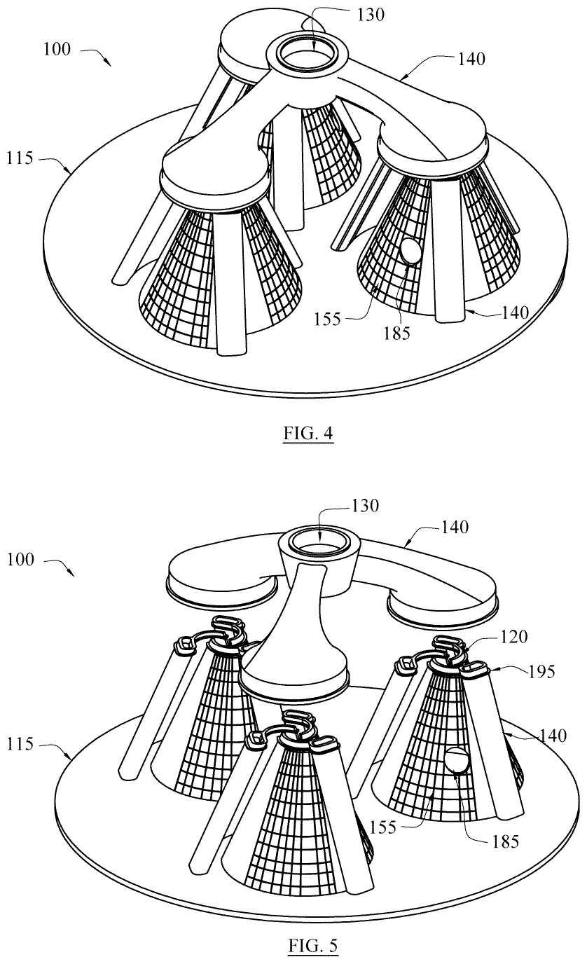

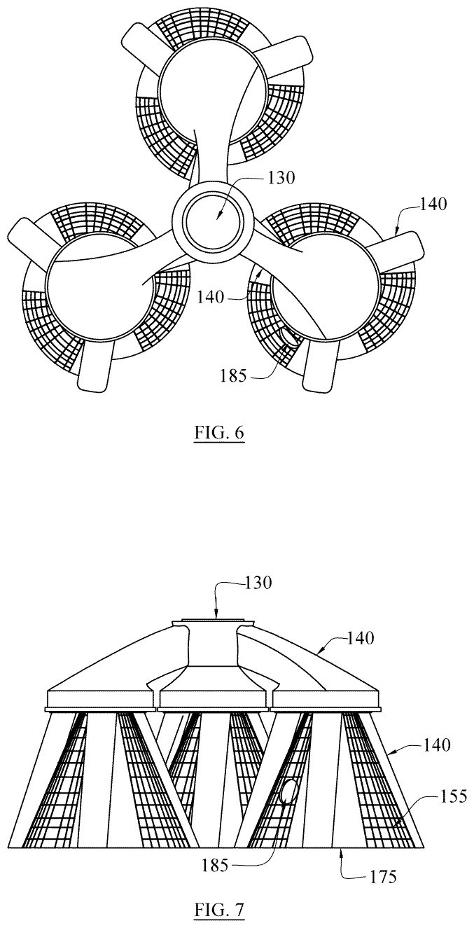

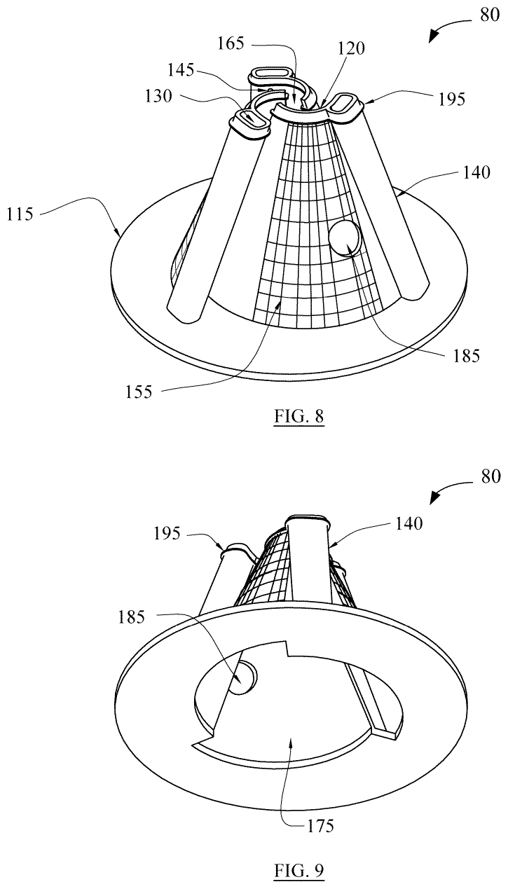

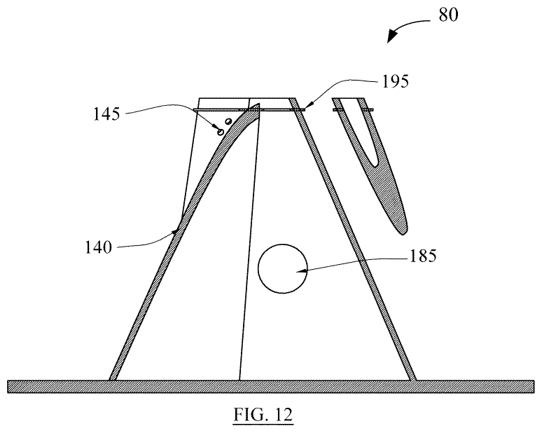

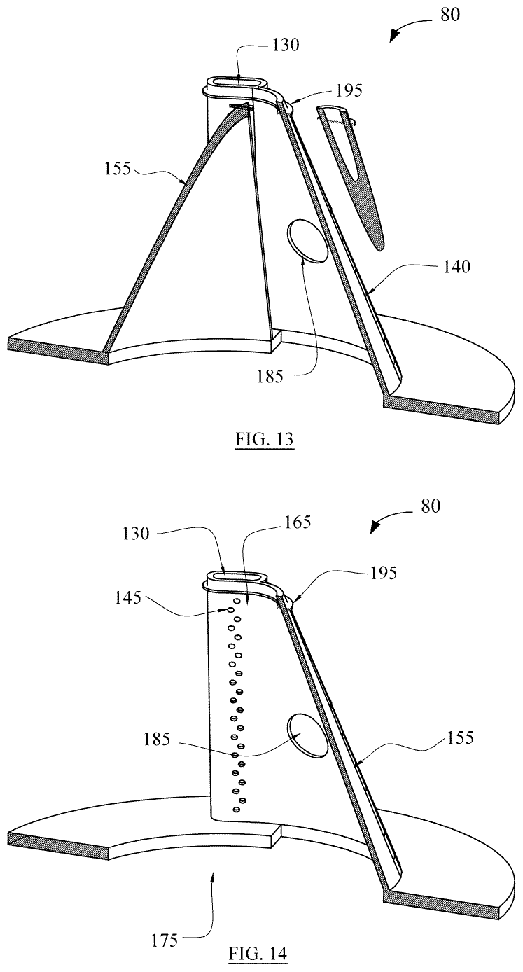

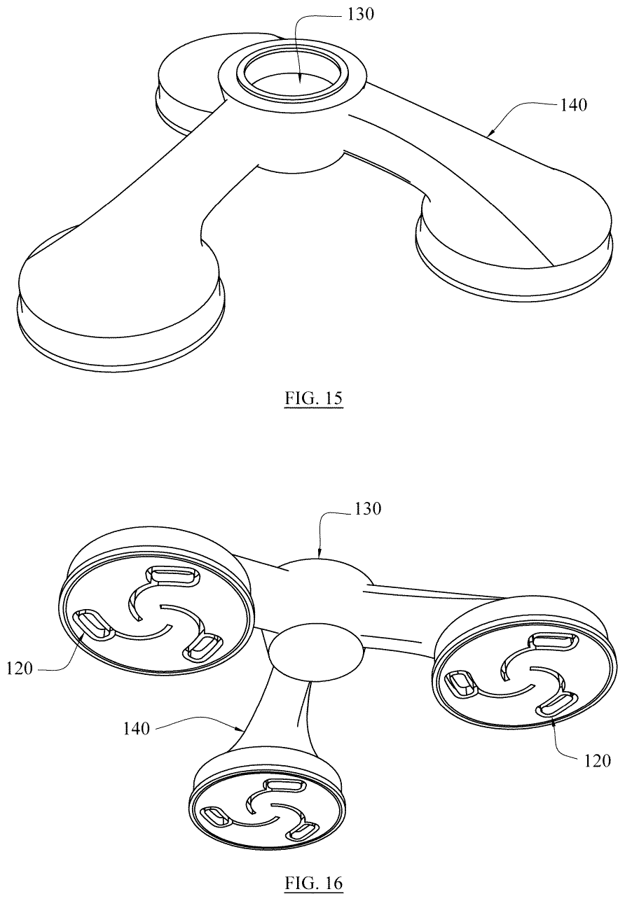

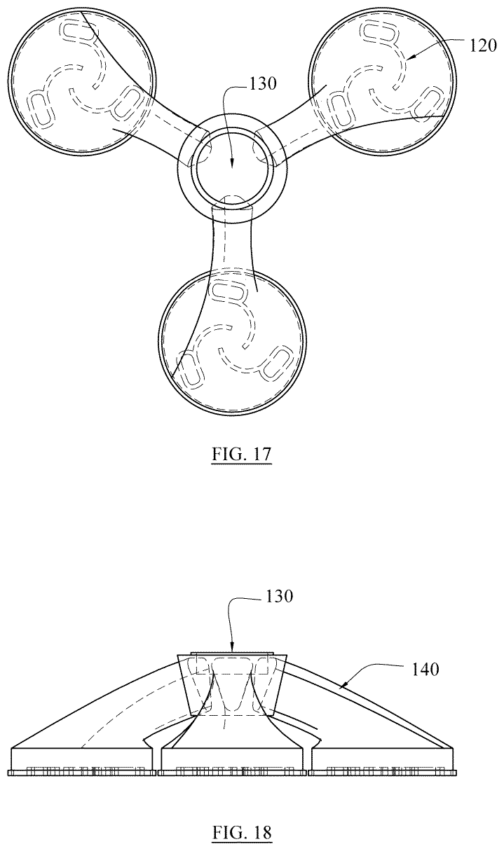

FIGS. 4-18 illustrate a combustor assembly for a converted turbofan engine according to one or more embodiments. A plurality of combustor assemblies 100 reside within the combustion chamber 122a of the converted engine 110, with the natural gas fuel system 190 providing natural gas fuel to the combustion chamber 122a. The combustor assembly 100 comprises a housing 115, a plurality of cone modules 80 coupled to the housing 115 at a first end of the cone modules 80, and a fuel distribution manifold 130 residing proximate to a second end of the plurality of cone modules 80. Each cone module 80 comprises an air admission slot 120, as described further below. The combustor assembly 100 further comprises a plurality of injection tubes 140 coupled to the fuel distribution manifold 130 and to each of the cone modules 80. Each injection tube 140 comprises a plurality of fuel apertures 145. Each cone module 80 further comprises a combustion chamber 155, a cyclonic inlet region 165, a vortex breakdown zone 175, and an ignition port 185. The housing 115 further comprises a mounting flange 195.

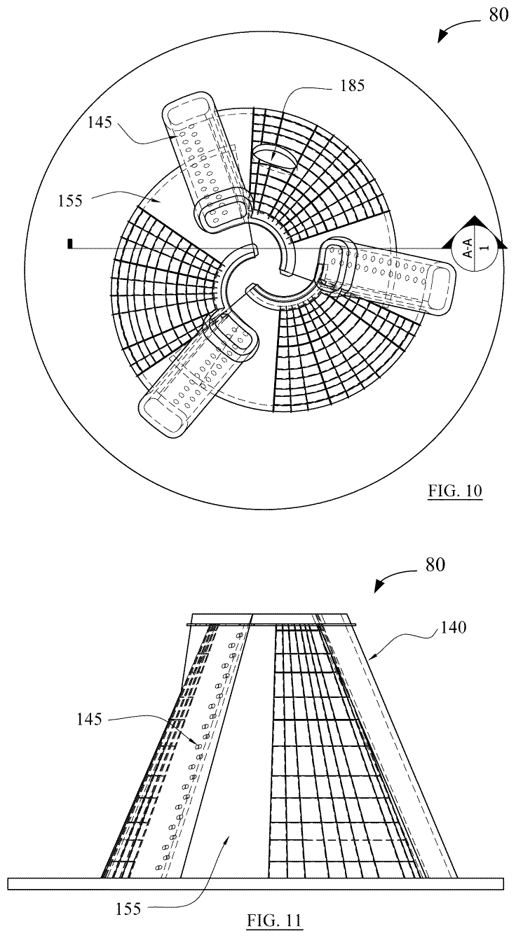

Compressed air enters the housing 115 through air admission slots 120, where the structure of the air admission slots 120 generates a cyclonic air flow, forming a cyclonic inlet region 165 (see FIG. 8) where the velocity of the cyclonic air flow exceeds flame propagation speed. Fuel supplied to the fuel distribution manifold 130 flows through injection tubes 140 and exits via fuel apertures 145 (see FIGS. 10 and 11), mixing with incoming air. The fuel-air mixture advances into the combustion chamber 155, which includes a mesh-patterned or perforated wall to enhance mixing and flame stabilization. Ignition occurs downstream of the vortex breakdown zone 175 via ignition port 185, ensuring that fuel-air mixing is substantially complete before flame stabilization. The mounting flange 195 supports the manifold and injection tubes. By reducing localized high-temperature regions and maintaining combustion temperatures below the threshold for significant thermal NOx formation, the combustor assembly 100 reduces emissions of nitrogen oxides and unburned hydrocarbons while maintaining combustion efficiency and stability.

### Inventive Converted Turboshaft Engine with Low Pressure Compressor 0-Stage Boost Blades

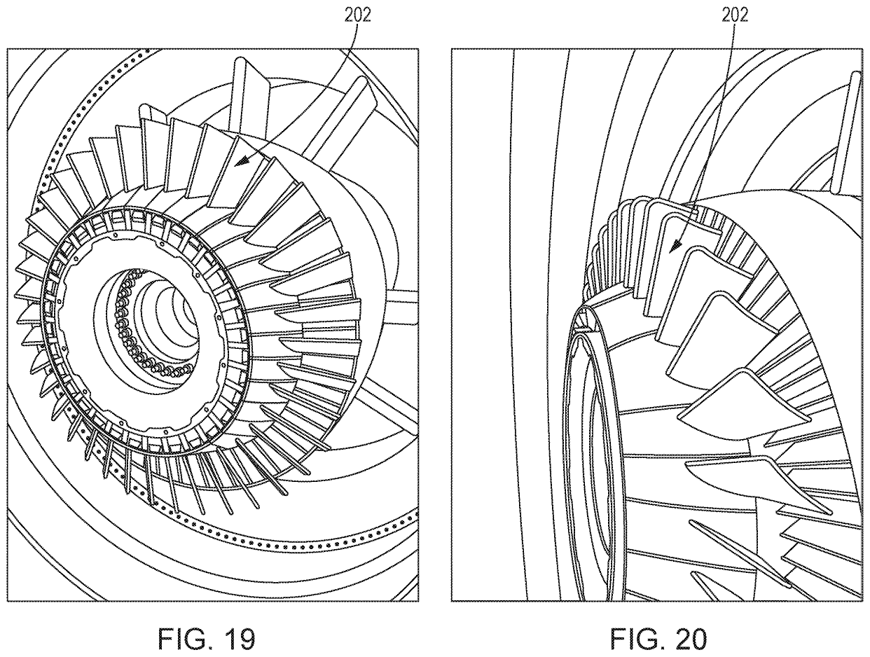

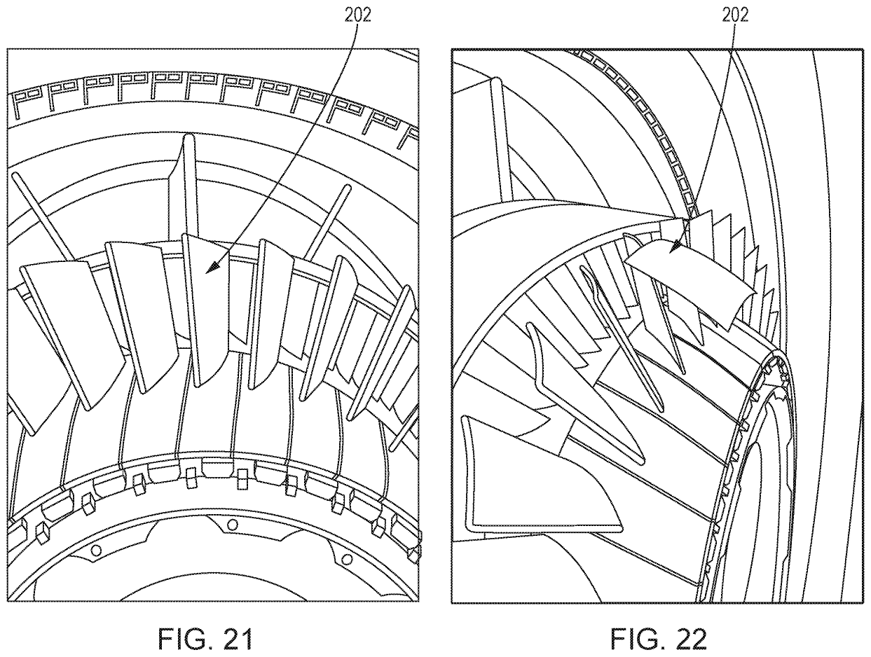

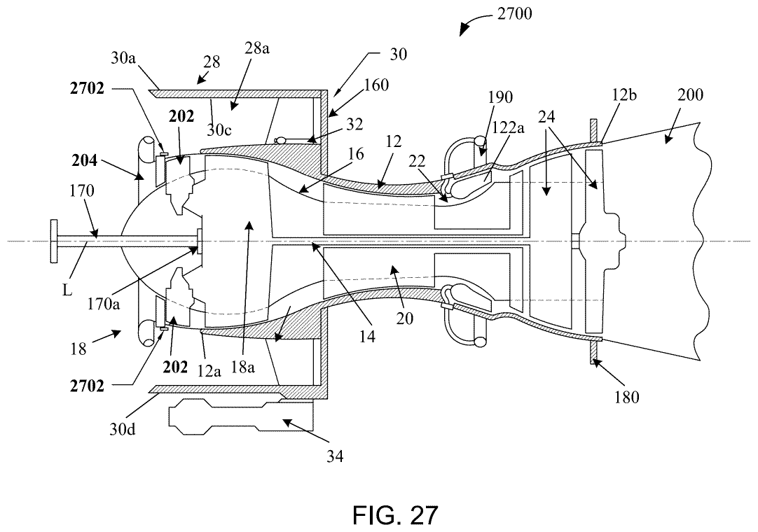

In one or more embodiments, as illustrated in FIG. 27, a converting engine 2700 includes a plurality of Low Pressure (LP) Compressor 0-Stage blade assembly 202. FIGS. 19-22 illustrate various perspective views of LP compressor 0-stage blades of the converted engine 2700 according to one or more embodiments. The LP compressor 0-stage blades 202 increase the mass flow through the core engine from a conventional aerodynamic/aeronautical rating (aero-rating) of 114 lb/sec to at least 130 lb/sec. The blades 202 can be manufactured from any suitable material for the centrifugal and aerodynamic loading experienced by the blading, e.g., 7000-Series heat treated aluminum, aerospace-grade titanium alloy, or carbon-composite.

The root of each blade 202 has an impulse profile, i.e., the same profile as the conventional bypass fan blades, which allows for the re-purposing of the bypass fan disk (not shown) for use with the blades 202. In one embodiment, to be effective at the maximum continuous relative shaft rotational and inlet air flow velocities, each blade 202 includes the following specifications:
Outer diameter, blade leading edge tip; 19.4″ (+/−.25″)
Inner diameter, Blade leading edge root; 12.95″ (+/−.25″)
Stagger angle at tip; 21.7 degrees. (+/−1.0 degrees.)
Stagger angle at root; 30.7 degrees. (+/−1.0 degrees.)
Chord width at tip; 3.1 inches. (+/−.25″)
Chord width at root; 3.1 inches. (+/−.25″)
C4 blade profile.
   Additionally, the 0-Stage blade chord will be moved to the rearward edge of the bypass fan disk roots, increasing net effective pressure recovery by the 0-Stage outlet guide vanes.

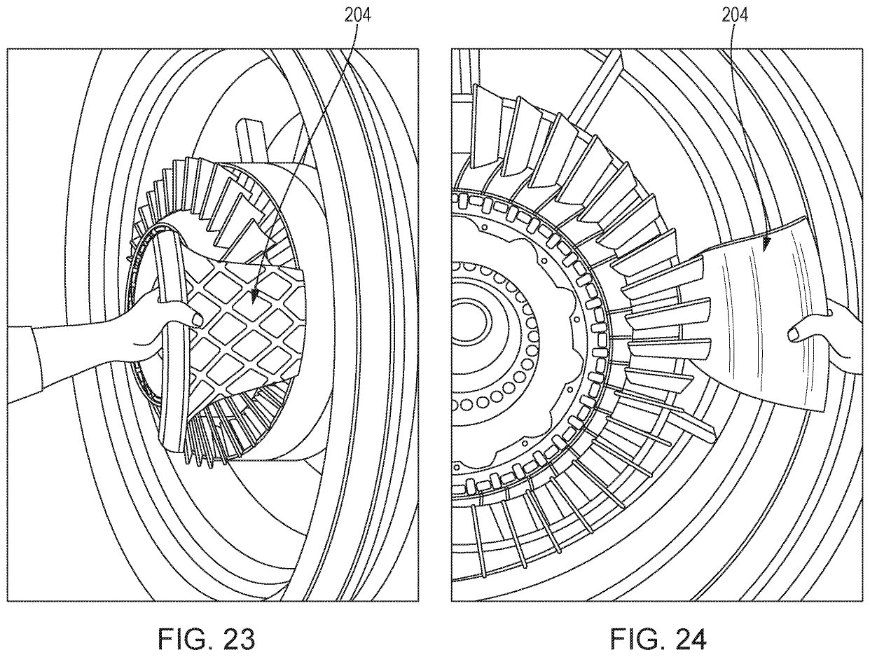

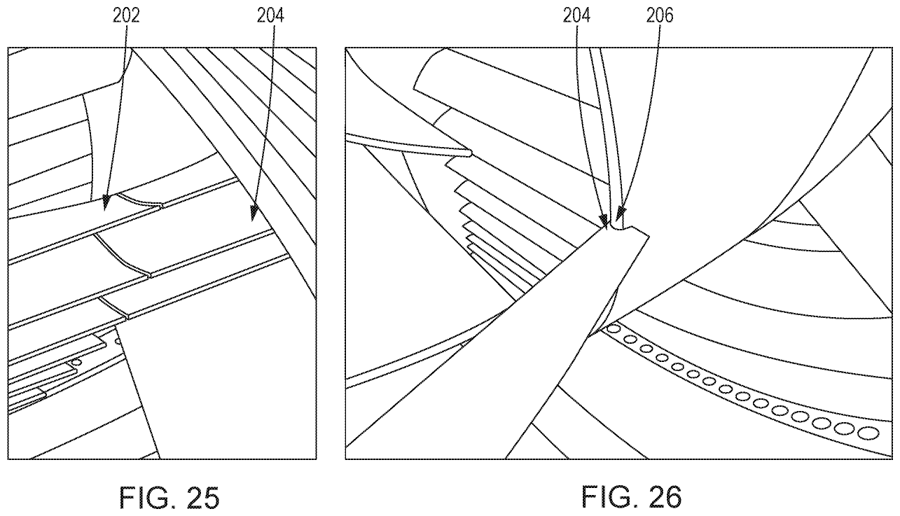

To maximise LP Compressor 0-Stage efficiency, and to provide smooth, laminar airflow into the engine LP Compressor, the converted engine 2700 incorporates an inlet bellmouth assembly. FIGS. 23 through 26 illustrate various views of an example section 204 of an inlet bellmouth assembly with the low pressure compressor 0-stage blade assembly. Although FIGS. 23 through 26 illustrate an example section 204 of the inlet bellmouth assembly, a complete inlet bellmouth assembly comprises a continuous ring surrounding the blades 202. As shown in FIG. 25, the inlet bellmouth assembly is fitted closely to the outer circumference of the LP Compressor 0-Stage blades 202 to minimize the distance between the blades 202 and the inlet bellmouth while preventing contact. As shown in FIG. 26, the inlet bellmouth assembly is further rigidly fastened to the LP Compressor 0-Stage outlet guide vane assembly 206 to prevent relative motion between them. The inlet bellmouth can be manufactured from any suitable material, e.g., spun aluminum, fiberglass, or carbon-composite material.

Referring again to FIG. 27, the variable incident angle inlet guide vanes (IGVs) 2702 are incorporated into the converted engine 2700 to promote core engine inlet air flow to enter the LP Compressor 0-Stage blading 202 at the correct angle, for all operating speeds and air flow conditions, where the LP Compressor 0-Stage compression ratio (i.e., ratio of air pressure at the compressor discharge to air pressure at the intake) is maximized. This further maximizes the aerodynamic efficiency and provides reliable compressor surge margin (i.e., the safety buffer/margin of safety between the compressor's steady operating point and a “surge line” or limit where the airflow becomes unstable, breaks down, or reverses) over a wide operating speed range. These IGVs 2702 are fitted to the inlet bellmouth assembly 204, where the IGVs 2702 are actuated via 90 degree lever arms (not shown), fitted to each individual vane, and to an actuating ring (not shown) that encircles the outer diameter of the inlet bellmouth assembly and connects to the IGV lever arms. The actuating ring is rotated by two (2) hydraulic rams (not shown), with an actuating force provided by an on-engine hydraulic pump and controlled off-engine by an engine control system programable logic controller.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

1. A method of converting engines into converted engines, wherein the method includes:
providing an engine having:
a body having a first end, a second end that is opposite the first end, and a fluid pathway that extends from the first end of the body to the second end of the body to control direction of fluid moving through body;
a shaft that is disposed within the body;
a bypass duct that is disposed on the body, wherein the bypass duct includes a first end, a second end that is opposite the first end, and a bypass opening extending from the first end of the bypass duct to the second end of the bypass duct;
a fan disposed at the first end of the body and connected to the shaft, wherein the fan includes one or more fan blades that rotate to draw fluid into the fluid pathway and the first end of the bypass duct;
a converging exhaust duct disposed at the second end of the body, wherein the converging exhaust duct is configured to increase speed of exhaust exiting the body; and
a valve that is configured to control flow of fluid from the fluid pathway of the body into the bypass duct; and
converting the engine into a converted engine by:
attaching an inlet bellmouth assembly to the first end of the body, such that an inner wall of the inlet bellmouth assembly covers the fan;
cutting the one or more fan blades or replacing the one or more fan blades to create one or more new fan blades, wherein a length of each new fan blade is selected such that a tip of the new fan blade is within a threshold distance to the inner wall of the inlet bellmouth assembly;
attaching a drive shaft to the shaft;
attaching a blanking plate to second end of the bypass duct, such that fluid flowing into the bypass duct from the fluid pathway of the body, via the valve, is blocked from exiting the bypass duct via the second end; and
replacing the converging exhaust duct with a diverging exhaust duct, wherein the diverging exhaust duct is configured to decrease speed of exhaust exiting the body.

2. Thet method of claim 1, wherein the engine belongs to the CFM56 series of turbofan engines that are manufactured by CFM International.

3. The method of claim 1, wherein the converted engine produces primarily shaft power.

4. A converted turbofan engine comprising:
a body having a first end, a second end that is opposite the first end, and a fluid pathway that extends from the first end of the body to the second end of the body to control direction of fluid moving through body;
a bypass duct that is disposed on the body, wherein the bypass duct includes a first end, a second end that is opposite the first end, and a bypass opening extending from the first end of the bypass duct to the second end of the bypass duct, wherein the bypass duct includes a mounting plate attached to the second end of the bypass duct;
an inlet bellmouth assembly connected to the first end of the body, wherein the inlet bellmouth assembly includes an inner wall;
a drive shaft that is connected to a shaft disposed within the body;
a fan, disposed at the first end of the body and connected to the shaft, such that the fan is covered by the inlet bellmouth assembly, wherein the fan includes one or more fan blades that each have a length such that a tip of the fan blade is within a threshold distance to the inner wall of the inlet bellmouth assembly; and
a diverging exhaust duct disposed at the second end of the body, wherein the diverging exhaust duct is configured to decrease speed of exhaust exiting the body.

5. The converted turbofan engine according to claim 4, further comprising:
a valve that is configured to control flow of fluid from the fluid pathway of the body into the bypass duct,
wherein the valve includes an open configuration, in which the one or more valves allow at least a portion of fluid flowing in the fluid pathway of the body to flow into the bypass duct, such that the fluid exits from the first end of the bypass duct to recirculate into the fan via the inlet bellmouth assembly, and
wherein the valve includes a closed configuration, in which the valve blocks fluid flowing in the fluid pathway of the body from flowing into the bypass duct.

6. The converted turbofan engine according to claim 4, further comprising:
a plenum that is attached to the inlet bellmouth assembly, wherein the plenum directs fluid into the inlet bellmouth assembly and reduces noise originating from a front of the converted engine.

7. The converted turbofan engine according to claim 4, further comprising:
a torque reaction mounting plate that is configured to prevent twisting of the converted turbofan engine during operation, wherein the torque reaction mounting plate is attached to one or more skid rails and the second end of the body.

8. The converted turbofan engine according to claim 4, wherein the shaft includes one or more bolt holes to which the fan and one or more flanges of the drive shaft are mounted via one or more bolts.

9. The converted turbofan engine according to claim 4, further comprising a combustor assembly, the combustor assembly comprising:
a housing;
a fuel distribution manifold;
a plurality of injection tubes coupled to the fuel distribution manifold, wherein each injection tube comprises a plurality of fuel apertures;
a plurality of cone modules, wherein a first end of the plurality of cone modules is coupled to the housing, and the fuel distribution manifold resides proximate to a second end of the plurality of cone modules, wherein each injection is coupled to one of the plurality of cone modules, wherein each cone module comprises:
a plurality of air admission slots;
a combustion chamber;
an ignition port; and
a vortex breakdown zone,
wherein fuel and air are premixed in the combustion chamber prior to combustion and ignition downstream in the vortex breakdown zone.

10. The converted turbofan engine according to claim 9, wherein the combustion chamber comprises a mesh-patterned wall.

11. The converted turbofan engine according to claim 9, wherein air flowing through the plurality of air admission slots form a cyclonic air flow with a velocity that exceeds flame propagation speed.

12. The converted turbofan engine according to claim 9, wherein the premixed fuel and air comprises a substantially stoichiometric mixture.

13. The converted turbofan engine according to claim 4, further comprising a plurality of low pressure compressor 0-stage blades.
